(19) United States
(12) Patent Application Publication
(10) Pub. No.: US 2006/0216389 A1
(43) Pub. Date: Sep. 28, 2006

(54) Rolled food item and method for formation of same

(76) Inventors: Sylvia Schonauer, Battle Creek, MI (US); Brian Reifsteck, Battle Creek, MI (US)

Correspondence Address: RANDALL L. SHOEMAKER;Dickinson Wright, PLLC, Ste. 2000, 38528 Woodward Ave, Bloomfield Hills, MI, 48304-2970, US

(21) Appl. No.: 11/387,394

(22) Filed: Mar. 23, 2006

Related U.S. Application Data
(60) Provisional application No. 60/664,345, filed on Mar. 23, 2005.

(51) Int. Cl. A21D 10/00

(52) U.S. Cl. 426/549

(57) ABSTRACT

A rolled food product and method for making the same is disclosed. The rolled food product comprises a plurality of individual strands that are joined together and rolled to form a rolled food product having multiple strands that can be peeled individually from the rolled food product. The structure has enhanced play value and appeal to consumers.

### RELATED APPLICATIONS

This application claims the benefit of U.S. Provisional application No. 60/664,345, filed on Mar. 23, 2005.

### STATEMENT REGARDING FEDERALLY SPONSORED RESEARCH

NONE

### TECHNICAL FIELD

The present invention generally relates to a rolled food product comprising multiple strands and a method for making the same. More specifically, the present invention relates to a starch-based confectionary formulation used to make the rolled food product, a method for making the rolled food product, and an appealing and aesthetically pleasing shape of the rolled food product including multiple strands

### BACKGROUND OF THE INVENTION

In recent years, food manufacturers have increased the play value and visual attractiveness of their food products in hopes of obtaining or maintaining market share, particularly with young consumers. For instance, manufacturers often create food products that assume appealing shapes such as fish or animals. Manufacturers also produce food products that comprise multiple pieces that can be separated before consumption. Typically, multi-piece food products having multiple pieces are intended to provide amusement to young consumers and aesthetic appeal to older consumers.

In addition to increasing the play value and aesthetic appeal of their products, food manufacturers have also been trying to develop fruit-based confection products, which provide additional nutritional value for young consumers. Such confectionary fruit snacks are well known. For instance, U.S. Pat. No. 4,117,176 to Taylor et al. discloses a taffy-like confection made with real fruit pieces. Similarly, U.S. Pat. No. 5,554,410 to Bell et al. discloses a hard confection product made with fruit juice and U.S. Pat. No. 6,548,090 to Dwivedi discloses an extrudable confection made with fruit concentrate.

However, the prior art listed does not disclose a starch-based confectionary food product with high levels of fruit, particularly, such a food product that is rolled and has multiple strands that can be individually pulled off the roll to increase the play value and appeal of the food product. As a result, there is a need in the food industry for a rolled multiple stranded food product having high levels of fruit wherein the strands can be individually removed to increase the play value and appeal of the product.

### SUMMARY OF THE INVENTION

In general terms, this invention provides a rolled food product comprising a plurality of individual strands that are joined along their length. The strip of multiple strands is then rolled on itself to form a rolled food product. The individual strands are peelable from the rolled food product for long lengths, and preferably for their entire length. The rolled food product has great play value and appeal to consumers. The unique design and formulation permits the food product to maintain its rolled shape and yet remain peelable.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is flow chart of a process for formation of a rolled food product according to the present invention;

FIG. 2 is a portion of a die face for formation of the present invention;

FIG. 3 is a cross-section view of a hole in the die face shown in FIG. 2;

FIG. 4 is a photo of a winding mechanism according to the present invention;

FIG. 5 is a photo of a winding mechanism according to the present invention;

FIG. 6 is a photo of a winding mechanism according to the present invention;

FIG. 7 is a schematic view of a winding mechanism according to the present invention;

FIG. 8 is a schematic top plan view of a winding mechanism according to the present invention;

FIG. 9 is cross-sectional view of a winding mechanism and drop chute according to the present invention; and

FIG. 10 is a photo of a rolled food product in accordance with the present invention.

### DETAILED DESCRIPTION OF A PREFERRED EMBODIMENT

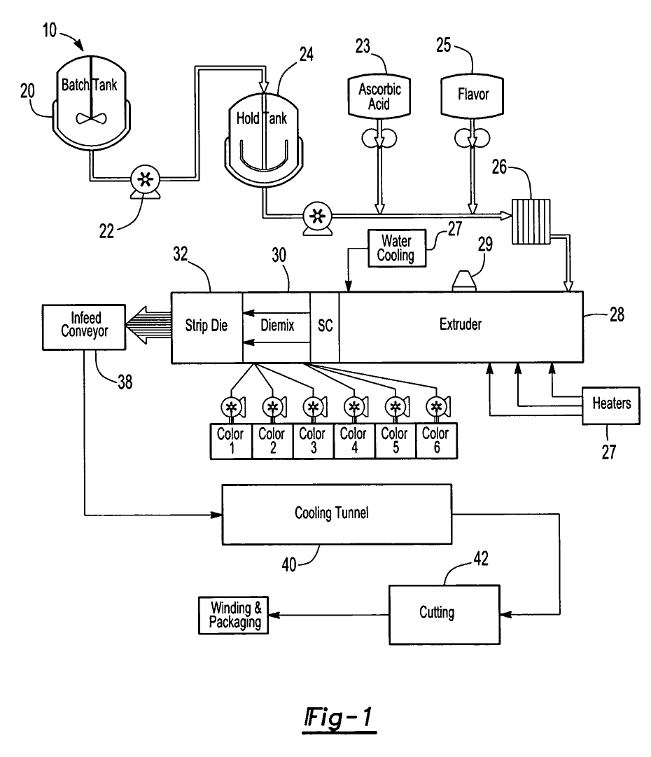

Formation of the present rolled food product begins with formation of an initial slurry as shown at 10 in FIG. 1. The formulation used to make the rolled food product is a starch-based confectionary formulation. Wheat flour is a preferred source of the starchy material in the rolled food product. Other food grade starches such as modified corn starch, or modified corn starch in combination with wheat flour could be used. Other food grade starches are know to those of ordinary skill in the art and will not be recited herein. In a mixture used to form the rolled food product, the starchy material comprises about 15 to 40% by weight, more preferably 20 to 35% by weight, and most preferably 25 to 30% by weight, all values or ranges based on weight are based on a total dry weight of the mixture used to form the rolled food product, unless otherwise noted. The use of wheat flour as the starchy material provides a substantial source of protein and overall nutritional value to the rolled food product. The wheat flour preferably has a protein content of 10 to 20% and more preferably has a protein content of 10 to 15%.

Sweetener provides the confectionary aspect of the formulation. The sweetener comprises 20 to 70% by weight of the mixture, more preferably 50 to 70% by weight, and most preferably 60 to 65% by weight of the mixture. The sweetener can be in the form of sugar, sucrose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, sugar alcohols, maltodextrin, or combinations thereof. It should be appreciated that a “no sugar added” product could also be formulated using sorbitol and other sugar alcohols.

The formulation also includes high levels of fruit from fruit powder, drum-dried fruit solids, freeze-dried fruit solids, evaporated fruit puree or fruit juice concentrate with at least 40% fruit solids. It should be noted that fruits such as cleaned, de-capped, fresh strawberries contain only 6 to 9.5 lbs. of solids per hundred-weight, i.e., 6 to 9.5% solids. Hence, the formulation provided herein uses a concentrated source of fruit. Preferably, the amount of fruit ranges from 1 to 25% by weight, more preferably from 1 to 10% by weight, and most preferably from 1 to 8% by weight.

The formulation preferably has from 0 to 5% of an edible oil or shortening. Examples of edible oils or shortenings that could be used include partially hydrogenated vegetable oils such as natural or hydrogenated soybean, cottonseed, canola, peanut, safflower, sunflower, coconut, palm, palm kernel, olive, butterfat, cocoa butter, tallow, lard, corn oil, or combinations thereof.

The formulation may have a humectant such as glycerin for moisture retention. The humectant is present in the mixture in a preferred amount of from 0 to 2%. Other examples of humectants that could be used include sorbitol solution, a mixture of glycerin and sorbitol, fructose, propylene glycol, or combinations thereof.

The formulation may include a food grade acid such as citric acid for modifying the pH of the slurry formed from the mixture. The food grade acid is present in the mixture in a preferred amount of from 0 to 3%. Other food grade acids that could be used include malic acid, tartaric acid, ascorbic acid, phosphoric acid, lactic acid, acetic acid, adipic acid, glucono delta lactone acid, fumaric acid, succinic acid, tarenic acid, or combinations thereof.

The formulation may include a buffer such as sodium citrate for controlling the pH. The buffer is present in the mixture in a preferred amount of from 0 to 1%.

Salt may be added to the formulation in a preferred amount of from 0 to 2% to provide flavor enhancement. The salt is chosen from, but is not limited to, sodium chloride, potassium chloride, calcium chloride, or combinations thereof.

The formulation may include an emulsifier such as glyceryl monostearate for maintaining the product softness over time. The emulsifier is present in the mixture in a preferred amount of from 0 to 3%. Other emulsifiers could also be used such as glycerol esters, diacetyl tartaric acids, esters of monoglycerides, mono and di-glycerides, polyglycerol esters, polysorbate, propylene glycol esters, rice extract esters, sodium stearoyl-2-lactylate, sorbitan esters, sugar esters, acetylated monoglycerides, lecithin, or combinations thereof.

A preservative such as potassium sorbate may also be present in the formulation in a preferred amount of from 0 to 1%. Other preservatives such as sodium propionate or potassium benzoate could be used as well.

It should be appreciated that the edible oil, humectant, food grade acid, buffer, salt, emulsifier, and preservative are optional ingredients.

The ranges that can be used for each of the ingredients in the initial food mass slurry are listed in TABLE 1 below with a preferred range, a more preferred range, and a most preferred range. For instance, referring to TABLE 1, the amount of starchy material, e.g., wheat flour, used to prepare the slurry preferably ranges from approximately 15 to 40%, more preferably from 20 to 35%, and most preferably from 25 to 30% based on a total dry weight of the mixture used to form the rolled food product. Water is also added to the initial slurry as required to achieve the desired final Brix of 74 to 79, more preferably from 75 to 78.

TABLE 1

| | Preferred | More Preferred | Most preferred |
|---|---|---|---|
| INGREDIENT | % Dry wt. | % Dry wt. | % Dry wt. |
| Starchy Material | 15-40 | 20-35 | 25-30 |
| (Wheat Flour) | (15-40) | (20-35) | (25-30) |
| (Corn Starch) | (0-10) | (0-5) | (0-2) |
| Sweetener | 20-70 | 50-70 | 60-65 |
| Fruit | 1-25 | 1-10 | 1-8 |
| Edible Oil | 0-5 | 0-3 | 1-3 |
| Humectant | 0-2 | 0-1.5 | 0.3-1 |
| Food Grade Acid | 0-3 | 0-1 | 0-0.5 |
| Buffer | 0-1 | 0-0.5 | 0-0.3 |
| Salt | 0-2 | 0-1 | 0-0.5 |
| Emulsifier | 0-3 | 0-2 | 0-0.5 |
| Preservatives | 0-1 | 0-0.1 | 0-0.05 |
| Total | 100.00 | 100.00 | 100.00 |

The initial food mass slurry is formed in a batch tank 20 with mixing and kept at about 170° F. to dissolve the components and to make them pumpable. One formulation for making an initial food mass slurry is presented in Table 2 below formed in the manner described below.

TABLE 2

| | Weight % as % |
|---|---|
| Ingredient | of total slurry mass |
| Corn syrup 63 Dextrose Equivalent (DE) | 26.85 |
| Enriched Red Spring Wheat (has 13% protein) | 24.35 |
| Fine, granulated sugar | 21.60 |
| Apple/Pear juice concentrate | 7.18 |
| Highly modified waxy corn starch (Rezista 682) | 5.00 |
| Partially hydrogenated soybean oil | 1.79 |
| Citric acid | 1.20 |
| Glycerol monostearate | 0.90 |
| Glycerin | 0.51 |
| High grade salt | 0.51 |
| Sodium citrate | 0.51 |
| Potassium sorbate | 0.06 |
| Water | 9.54 |

In the batch tank 20 the corn syrup, wheat flour, sugar, and corn starch are mixed. Then the oil, glycerol, and potassium sorbate, which is dissolved in some of the water, are added to the tank 20. Next the salt, glycerol monostearate, citric acid and another portion of the water are added to the tank 20. The mixing is continued for 15 minutes or until all of the lumps are gone. Then the fruit juice concentrate and the rest of the water are added to the tank 20. The slurry is heated to 170° F. and mixed for an additional 30 minutes. It is then pumped via a pump 22 to a slurry holding tank 24. Preferably the slurry has a Brix of from 74 to 79, more preferably Brix of from 75 to 78.

The formed slurry is optionally pumped from the holding tank 24 through a heat exchanger 26 to heat the mass up to about 200° F. This adds in increasing the throughput of the system, but is not necessary. In addition, during this pumping additional ascorbic acid 23 preferably at a level of 0.072% by weight based on the final weight can be added to raise the vitamin C level of the rolled food product as shown in FIG. 1. Another optional addition can be addition of the flavoring 25 while the initial food mass slurry is being pumped through the heat exchanger 26 as shown in FIG. 1

The food mass slurry from the holding tank 24 at a temperature of from about 160 to 200° F. is pumped into a twin screw cooker extruder 28, preferably a Krupp Werner & Pfleiderer™ W-P120 cooker/extruder. There are numerous possible extruder conditions, two possible extruder setups are disclosed below. In one embodiment, the extruder 28 has 9 zones and in the other it has 8 as described in Table 3 below. Preferably, each extruder 28 has a length to diameter ratio L/D of 33 to 32. The extruder barrels are surrounded by jackets 27 that receive either hot oil or chiller fluid. In the vent port portion of each extruder setup a vacuum 29 is pulled to further reduce the moisture level of the food mass.

TABLE 3

| Extruder | Mokon oil | Barrel | Extruder | Mokon oil | Barrel |
|---|---|---|---|---|---|
| 1 zone | setpoint ° F. | temperature ° F. | 2 zone | setpoint ° F. | temperature ° F. |
| 1 | None | Ambient | 0 | None | Ambient |
| Feed | | | Feed | | |
| zone | | | zone | | |
| 2 | 419 | 355 | 1 | 350-364 | 345-367 |
| Heat | | | Heat | | |
| 3 | 371 | 351 | 2 | 320-340 | 322-337 |
| Heat | | | Heat | | |
| 4 | 388 | 334 | 3 | 290-300 | 280-289 |
| Heat | | | Heat | | |
| 5 | 392 | 334 | 4 | 290-300 | 286-295 |
| Heat | | | Heat | | |
| 6 | Vacuum 12-14 | 211 | 5 | 290-300 | 284-292 |
| Vent | inches of | | Heat | | |
| port | Hg | | | | |
| 7 | 70 | 205 | 6 | Vacuum | 163-172 |
| Cooling | | | Vent | 12-14 | |
| | | | port | inches of | |
| | | | | Hg | |
| 8 | 70 | 190 | 7 | 70 | 196-200 |
| Cooling | | | Cooling | | |
| | | | 8 | 70 | 203-211 |
| | | | Cooling | | |
| | | | 9 | 70 | 194-203 |
| | | | Cooling | | |

The cooked food mass passes from the extruder 28 into a Diemix® unit 30 where it is split into a number of food streams. Such units are available from Extrufoods B.V., The Netherlands. The number of food streams depends on the desired final product configuration. For example, in one embodiment the final rolled food product comprises a product having 12 strands, divided into 6 pairs, with each pair having a different color to produce a 12 strand six color rolled configuration. In other embodiments, the rolled food item may have 3, 4 5, or more colors and or flavors. In the discussion below it will be assumed that the desired configuration is for a six colored roll having 12 strands, however other forms are possible. In the Diemix® unit 30 the food mass is split into 6 food streams each of which gets an injection of one of the specific colors. It is also possible to inject the flavor 25 and ascorbic acid 23 at this time if not done previously as described above. Three examples of six color combinations are given in Table 4 below in terms of % of final food weight, the remainder comprises the initial food mass slurry.

| | | | Example 3, |
|---|---|---|---|
| Ingredient | Example 1, % | Example 2, % | % |
| Red liquid color R | 0.09827 | 0.14765 | 0.14822 |
| 02234 | | | |
| Blue #2 01780 | 0.07002 | 0.0 | 0.06039 |
| Blue liquid color R | 0.05235 | 0.0 | 0.05233 |
| 01777 | | | |
| Red #40, 5.67% dye | 0.22755 | 0.28873 | 0.0 |
| sensient 00325 | | | |
| Red liquid color R | 0.11503 | 0.00897 | 0.0 |
| 02236 | | | |
| Flavor | 0.83882 | 0.0 | 0.0 |
| Opaque pink 52462 | 0.0 | 0.21753 | 0.0 |
| Opaque pink 52461 | 0.0 | 0.14813 | 0.0 |
| Flavor | 0.0 | 0.69956, 0.13901 | 0.0 |
| Flavor | 0.0 | 0.0 | 0.83884 |
| Liquid green color | 0.0 | 0.0 | 0.13380 |
| 01545 | | | |
| Orange (yellow #5 & | 0.0 | 0.0 | 0.10030 |
| red #40), 4.6% dye | | | |
| sensient #01450 | | | |
| Yellow #5, 4.7% dye | 0.0 | 0.0 | 0.09353 |
| sensient #00417 | | | |

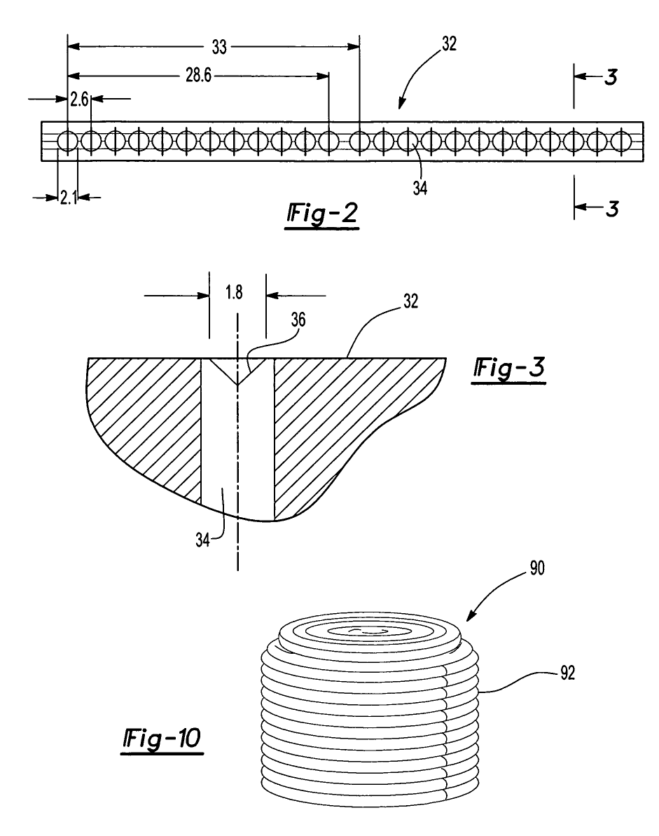

The injected and split food masses are then directed to a die face 32 and extruded through the die face 32, a portion of which is shown in FIG. 2, to form strands of the food product. In one embodiment, the die face 32 is designed to form 24 food product strands each comprising a six colored 12 stranded strip. A portion of a die face 32 is shown in FIG. 2. The die face 32 is composed of a series of aligned holes 34. In the face 32 shown it is designed to produce a series of 24 food product strips each of which is a 6 color 12 stranded strip. In this die face 32 the holes 34 preferably have a diameter of 2.1 millimeters, and are spaced apart by 2.6 millimeters measured from center to center. Preferably, the length of each series of 12 holes center to center is 28.6 millimeters as shown. Preferably the distance between each series of 12 holes 34 is 4.4 millimeters, 33 millimeters minus 28.6 millimeters, as shown. The Diemix® unit 30 directs each of the 6 colors to a pair of holes 34 in each series of 12 holes 34. As shown in FIG. 3 a V-shaped slot 36 is cut across the series of holes 34 on the out face side. Preferably the slot 36 has a width of approximately 1.8 millimeters at the widest and a depth of approximately 1.15 millimeters. The slot 36 helps to cause adjacent strands in each series of 12 to bond together during the extrusion to form a food product strip comprising 12 strands bonded together along their entire length.

Preferably, the extruded strips of food product have a final moisture content of about 14 to 16% with a water activity level of 0.66 to 0.68. The strips of food product are extruded onto an infeed conveyor 38 and are conveyed through a cooling tunnel 40 to cool the strips to a temperature of preferably about 70° F. Preferably the strips of food product are approximately 0.9 to 1.1 inch wide. The cooled strips of food product are then cut by a cutter unit 42 into lengths of approximately 15 inches, with a desired final weight of approximately 22 to 25 grams.

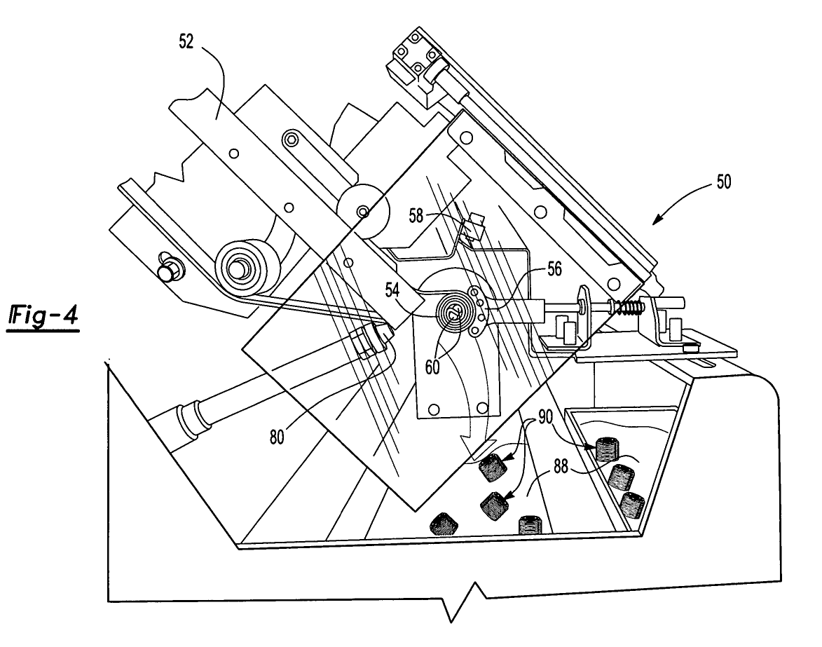

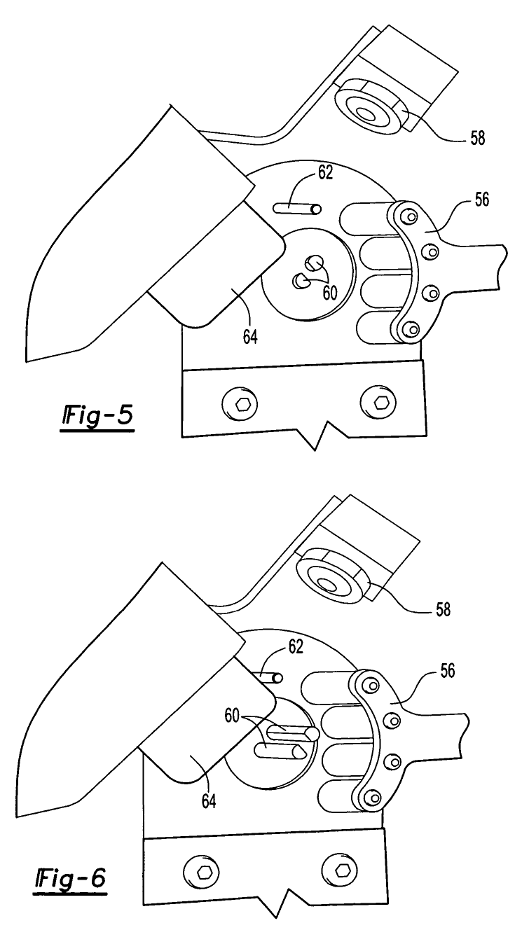

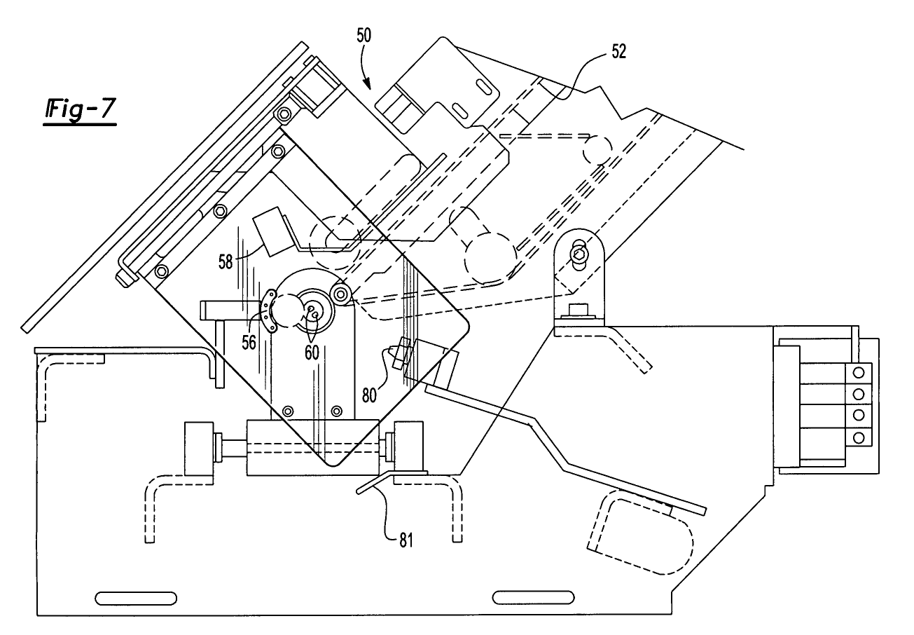

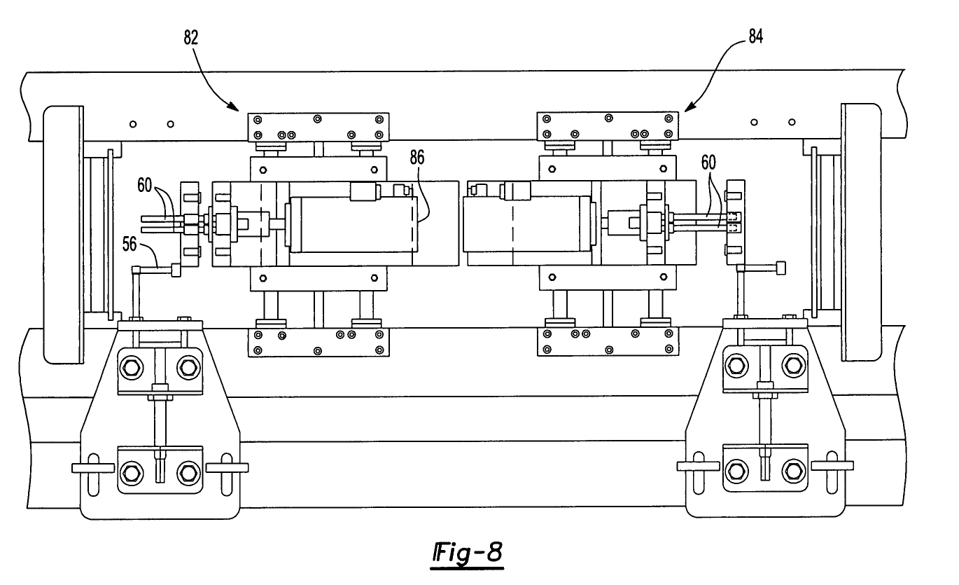

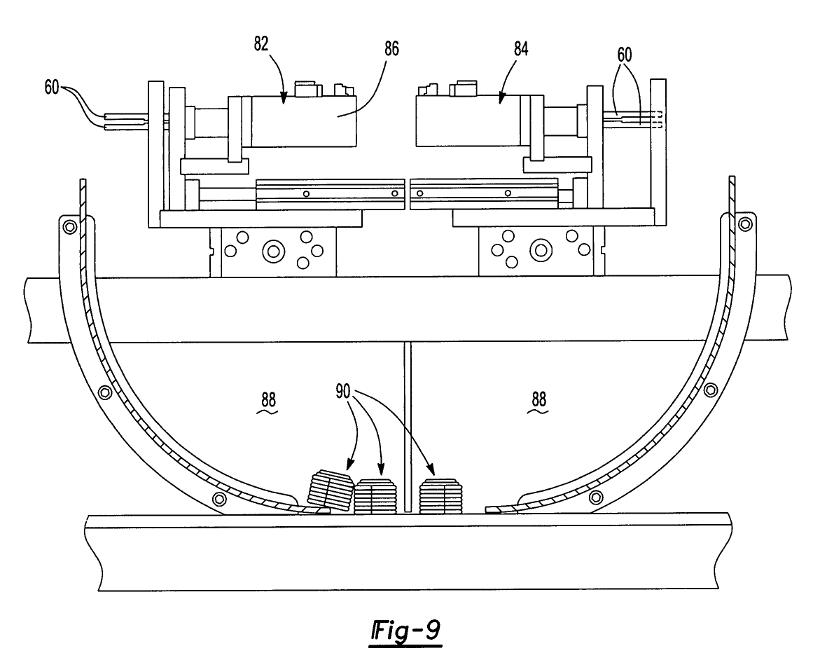

The cut strips of food product are then split off to a series of winding mechanisms 50 to be rolled into the final rolled food product. FIGS. 4-6 show the winding mechanism 50. A conveyor 52 delivers a cut strip of food product to the winding mechanism 50. In FIG. 4 a food product is shown partially rolled at 54. A compression roller mechanism 56 helps to maintain the food product rolled shape during the rolling operation. The mechanism 56 preferably comprises a plurality of rollers arranged in an arc as shown. A sensor 58 detects the leading and trailing ends of the strip of food product to control the winding mechanism 50. FIG. 5 is a closeup of the winding mechanism 50 at the start or home position. The mechanism 50 includes a pair of prongs 60 that are retracted at the home position as shown. It also includes a post 62 for helping to control the roll. In the home position a base 64 is slid toward the conveyor 52. In FIG. 6 the mechanism 50 is shown in the winding position. Here the prongs 60 are extended and the base 64 is slid toward the prongs 60 to feed the strip of food product between the prongs 60. FIG. 7 is a schematic drawing of the mechanism 50 further showing a water nozzle 80 for depositing a drop of water at the end of the roll to help in tacking the end of the roll as will be described below. FIG. 7 also shows the sensor 58 reflector 81. FIG. 8 is a schematic top plan view of a pair of mechanisms showing the prongs 60 extended on winder mechanism 82 and prongs retracted on mechanism 84. The prongs 60 are driven and moved by a servo motor 86. FIG. 9 is a cross-sectional schematic showing how the winding mechanisms 82, 84 are oriented over a drop chute 88. Once a strip is rolled the prongs are retracted and the rolled food product 90 drops into the drop chute 88. The drop chute 88 is designed to force the product 90 to orient as shown in the FIG. 9, which makes packaging easier.

Referring to FIGS. 4-9 the basic sequence of rolling is described below. The prongs 60 are at the home position and retracted, the base 64 is slid toward the conveyor 52. When the strip leading edge is detected by the detector 58 the sequence is started and the prongs 60 are extended. Once the prongs 60 are fully extended the servo motor 86 starts rotating the prongs 60 at approximately 22 rps. At the same time the base 64 is slid away from the conveyor 52. The product continues to be rolled until another sensor detects the trailing edge of the strip. At that time the servo motor 86 completes a set number of revolutions, generally about 1 to 2 and then it stops. Once the servo motor 86 stops the water nozzle 80 sprays water for typically about 0.06 seconds to deposit water on the trailing end. Then the servo motor 86 winds the roll for another 0.6 to 1.0 revolutions and then holds the roll with the compression roller 56 pressing against the roll for approximately 0.40 seconds to tack the end of the roll 90. The prongs 60 are then retracted and the roll 90 drops into the drop chute 88 and is moved into the desired orientation. The mechanism 50 then returns itself to the home position.

The rolls 90 are periodically taken from the chute 88 and transferred to a packaging conveyor. There the rolls are separated and then packaged using standard flow wrapper technology. The wrapper material is a metalized polyester fin sealed pouch that is cold sealed. The wrapper material is Milseal™ from Milprint, Inc. a Bemis company. The layers are as follows: oriented polypropylene, ink, adhesive, aluminum metallization, oriented polyester, and then the cold seal.

A rolled food product 90 according to the present invention is shown in FIG. 10. The product 90 comprises a plurality of strands 92 joined to adjacent strands along their length. Each strand 92 can be peeled from the remaining roll for significant distances. Preferably the strands 92 can be peeled for at least 2 inches, more preferably for 3 inches and most preferably for their entire length. This adds tremendously to the play value and appeal of the product 90 to consumers. The present rolled food product is unique in that there is no requirement for a substrate to prevent sticking of the roll to itself as has been the case with past rolled food items. In addition, the rolled food item does not require an outer coating of granulated sugar as have past rolled food items to prevent the roll from sticking to itself. As described above, the die face 32 creates a food strip having multiple strands wherein each strand is joined along its entire length to adjacent strands.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A rolled food product comprising a plurality of adjacent strands forming a strip, said strip rolled up upon itself for a plurality of revolutions, each of said strands joined to immediately adjacent strands along their entire length and wherein each strand is peelable from said rolled food product for a distance of at least 2 inches.

2. The rolled food product of claim 1 wherein each of said strands is individually peelable from said rolled food product for a distance of at least 3 inches.

3. The rolled food product of claim 1 comprising from 15 to 40 percent by weight of starch, from 20 to 70 percent by weight sweetener, from 1 to 25 percent by weight fruit, from 0 to 5 percent by weight edible oil, from 0 to 2 percent by weight humectant, from 0 to 3 percent by weight of a food grade acid, from 0 to 2 percent by weight of a salt, from 0 to 3 percent by weight of an emulsifier, and from 0 to 1 percent by weight of a preservative.

4. The rolled food product of claim 3 comprising from 20 to 35 percent by weight starch.

5. The rolled food product of claim 3 comprising from 25 to 30 percent by weight starch.

6. The rolled food product of claim 3 wherein said starch comprises at least wheat flour, modified corn starch, or a mixture thereof.

7. The rolled food product of claim 3 comprising from 50 to 70 percent by weight sweetener.

8. The rolled food product of claim 3 comprising from 60 to 65 percent by weight sweetener.

9. The rolled food product of claim 3 comprising from 1 to 10 percent by weight fruit.

10. The rolled food product of claim 3 comprising from 1 to 8 percent by weight fruit.

11. The rolled food product of claim 3 wherein said fruit is selected from the group consisting of a fruit powder, a drum dried fruit solid, a freeze dried fruit solid, an evaporated fruit puree with at least 40% fruit solids, a fruit juice concentrate with at least 40% fruit solids, or mixtures thereof.

12. The rolled food product of claim 1 wherein at least two of said plurality of strands have a different color from each other.

13. The rolled food product of claim 1 wherein at least two of said plurality of strands have a different flavor from each other.

14. The rolled food product of claim 1 comprising at least 6 strands.

15. The rolled food product of claim 1 wherein each strand has a diameter of at least 2 millimeters.

16. The rolled food product of claim 1 wherein said rolled food product has a moisture level of from 14 to 16 percent by weight.

17. The rolled food product of claim 1 wherein said rolled food product has a water activity level of from 0.66 to 0.68.

18. The rolled food product of claim 1 wherein said rolled food product has a weigh of from 22 to 25 grams.
